(19) United States
(12) Patent Application Publication
(10) Pub. No.: US 2008/0168371 A1
(43) Pub. Date: Jul. 10, 2008

(54) Apparatus and method for choosing an ad provider

(75) Inventor: Daryl David Coutts, Edmonton (CA)

Correspondence Address: Daryl D. Coutts, 11103 84 Ave , Suite 207, Edmonton, AB, T6G2X4, omitted

(73) Assignee: Marengo Intellectual Property Ltd., Edmonton (CA)

(21) Appl. No.: 12/071,734

(22) Filed: Feb. 26, 2008

Related U.S. Application Data
(60) Provisional application No. 60/903,515, filed on Feb. 27, 2007.

(51) Int. Cl. G06F 3/048

(52) U.S. Cl. 715/764

(57) ABSTRACT

An apparatus and method for facilitating the selection of an ad provider for a computing device is described.

### CROSS REFERENCE TO RELATED APPLICATIONS

This application claims the benefit of priority under 35 USC 119(e) to U.S. Provisional Application No. 60/903,515, filed Feb. 27, 2007, entitled “Apparatus and Method for Choosing an Ad Provider”, all of which is incorporated herein by reference in its entirety.

### TECHNICAL FIELD

The invention relates to an apparatus and method that allows a user of a computing device to choose which ad provider gets to deliver advertisements to the user's computing device.

### BACKGROUND OF THE INVENTION

Internet advertising is an important part of a computer user's online experience. Often, useful information on the internet is provided concurrently with advertising in order to pay for the development and presentation of the information. However, some advertising on the internet can be more racy than what the computer user desires. Also, some advertising on the internet can be too obtrusive for the computer user, which impedes the computer user in obtaining useful information.

What is needed is a method that allows a user of a computing device to select which companies or services provide advertisements to their computing device. What is needed is an apparatus and method that allows a user to choose an ad provider for their computing device.

### BRIEF SUMMARY OF THE INVENTION

A computer program product running on a computing device with an associated display, presents a user interface on the display. The user interface is configured to allow a user to choose an ad provider. Upon receiving an indication of a selected ad provider, the computer program product stores data corresponding to the selected ad provider in a memory associated with the computing device.

The user interface may comprise a drop down list box that contains a list of possible ad providers. Further, the data corresponding to the selected ad provider may be transmitted from the computing device to a server. Still further, a document on the computing device may be modified based on the selected ad provider.

Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary block diagram of several software modules running on a computing device.

FIG. 2 illustrates an exemplary method that can be used to select an ad provider for a computing device.

FIG. 3 illustrates a user interface configured to allow selection of an ad provider.

### DESCRIPTION OF EMBODIMENTS

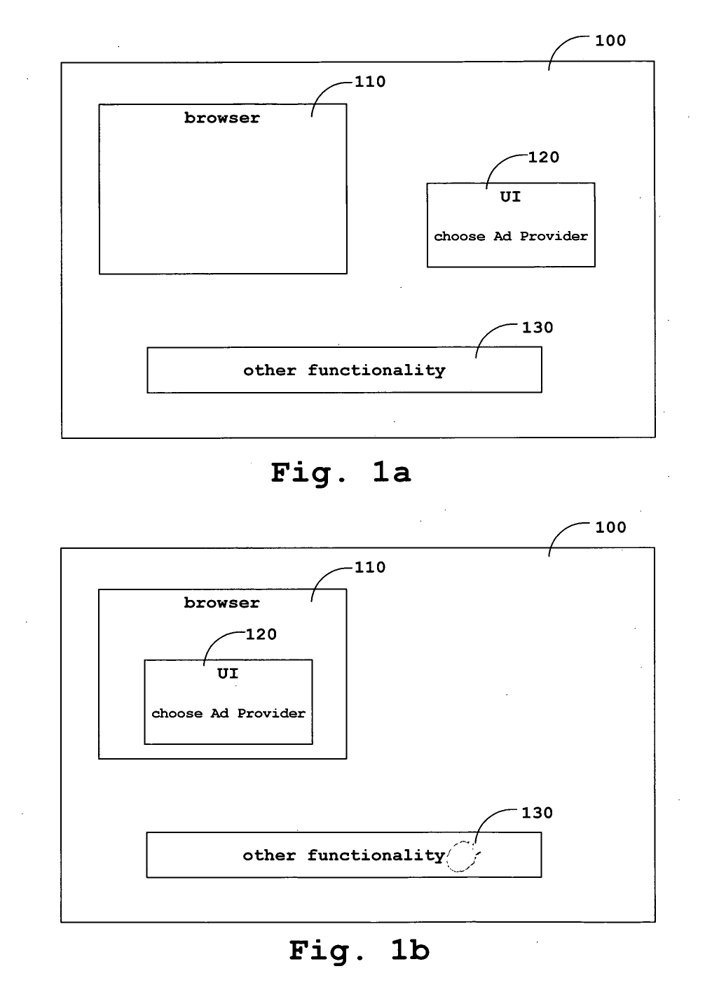

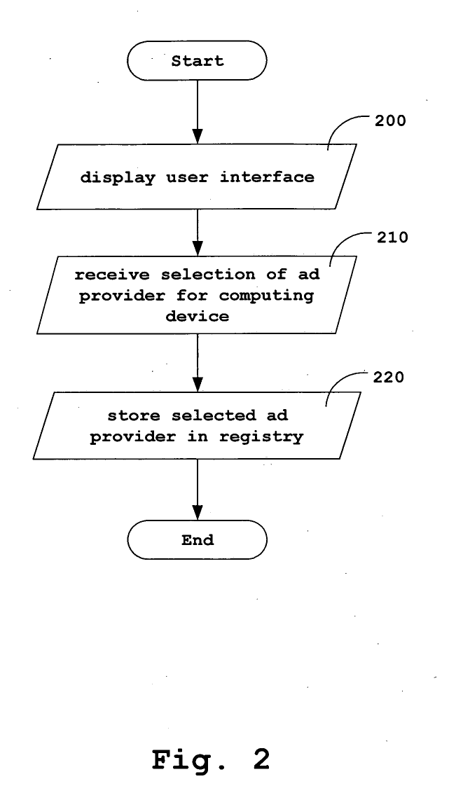

FIG. 1a is a block diagram of several software modules running on a computing device 100. The computing device 100 can be any computing device such as a desktop computer, notebook computer, cellphone, personal digital assistant, handheld computer or set top box. The computing device 100 has memory, not shown, that can be permanent or temporary or both permanent and temporary. The computing device 100 also has an associated display that is not shown in FIG. 1. Block 110 represents a web browser. Block 120 is a user interface configured to allow selection of an ad provider for the client computer 100. Block 120 is discussed in detail later in the description of FIG. 2. Block 130 represents other software modules executing on the client computer 100 such as the operating system and communication system. FIG. 1a shows the user interface 120 separate from the web browser 110. FIG. 1b shows that the user interface 120 can be integrated into the web browser 110 functionality.

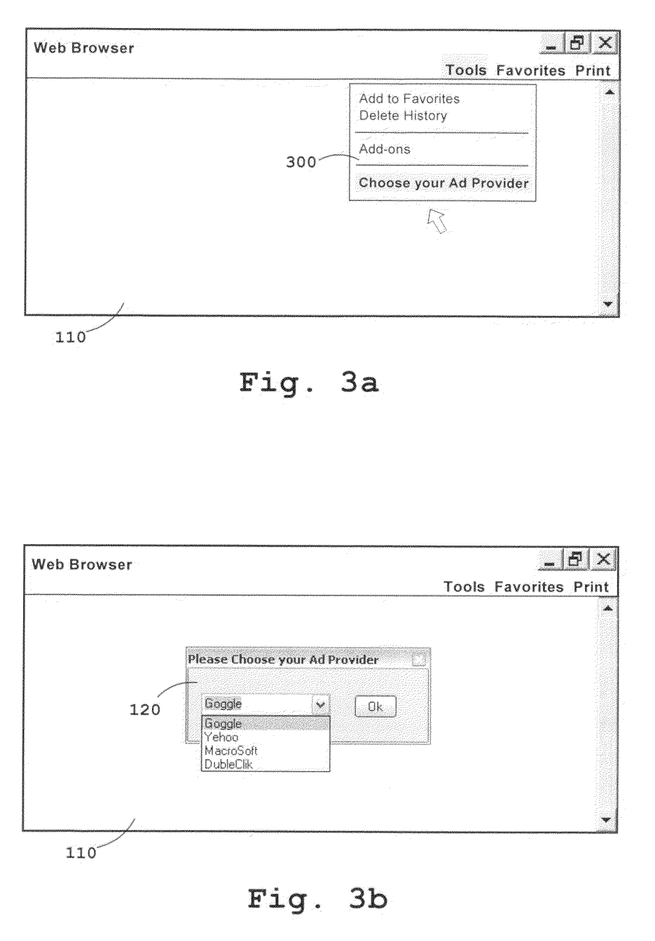

FIG. 2 illustrates a method that can be implemented to facilitate the selection of an ad provider for the computing device 100. In block 200 the user interface 120 is displayed, this can be the result of a user clicking on a user interface element 300 as shown in FIG. 3a. The user interface 120 can be displayed in response to other events also. The user interface 120 is shown in FIG. 3b. The user interface 120 can comprise a drop down listbox that when selected presents a list of ad providers. The user interface 120 can comprise other user interface elements and may not use a drop down list box as shown in FIG. 3b.

In block 210 of FIG. 2, the selection of an ad provider for the computing device 100 is received and in block 220 data corresponding to the selected ad provider can be stored in the registry of the computing device. Receiving the selection of an ad provider can also be described as receiving an indication of an ad provider. The data corresponding to the selected ad provider may be stored in memory other than the registry, such as a text file on the hard drive. Also, the data corresponding to the selected ad provider may be transmitted and stored on a server. Further, documents on the computing device 100, such as a web page in the web browser 110, may be modified based on the data corresponding to the selected ad provider.

The method illustrated in FIG. 2 can be distributed across plural applications. For instance, the display of the user interface could be handled by an add-on to the web browser 110, while the storing of the selected ad provider could be handled by an application distinct from the web browser 110. Also, the web browser 110 is not a requirement for the method illustrated in FIG. 2. The functionality described herein may be implemented in a web browser add-on, add-in, extension, plug-in, helper object or any other type of application function extender. Computer executable instructions for carrying out the method illustrated in FIG. 2 may be stored on any suitable media readable by a computer such as floppy disks, hard disks, CD-ROMS, DVDs, Flash ROMs, non-volatile ROM and RAM.

While various embodiments have been described above, it should be understood that they have been presented by way of example only, and not limitation.

I claim:

1. A method of selecting an ad provider for a computing device, the computing device having a display and the ad provider involved in a process of providing ads for display on the display, the method comprising:
providing a user interface on the display, the user interface configured to allow selection of an ad provider;
receiving an indication of a first ad provider; and
storing data corresponding to the first ad provider in a memory associated with the computing device.

2. The method of claim 1 where the user interface comprises a drop down list box that when selected presents a list of ad providers.

3. The method of claim 1 where the user interface is displayed in response to a user indication directed at a user interface element in a web browser.

4. The method of claim 1 where storing data corresponding to the first ad provider comprises transmitting the data to a server whereby the server can deliver ads to the computing device that correspond to the first ad provider.

5. The method of claim 1 where storing data corresponding to the first ad provider comprises storing the data in a registry or hard drive on the computing device.

6. The method of claim 5 further comprising modifying a document on the computing device based on the data.

7. A web browser add-on that performs a method of selecting an ad provider, the method comprising:
providing a user interface on the display, the user interface configured to allow selection of an ad provider;
receiving an indication of a first ad provider; and
storing data corresponding to the first ad provider in a memory associated with the computing device.

8. The web browser add-on in claim 7 that performs a method of selecting an ad provider, wherein the method the user interface is displayed, the user interface comprises a drop down list box that when selected presents a list of ad providers.

9. The web browser add-on in claim 7 wherein the user interface is displayed in response to a user indication directed at a user interface element in a web browser.

10. The web browser add-on in claim 7 wherein performing the method of selecting the ad provider, storing data corresponding to the first ad provider comprises transmitting the data to a server whereby the server can deliver ads to the computing device that correspond to the first ad provider.

11. The web browser add-on in claim 7 wherein performing the method of selecting the ad provider, storing data corresponding to the first ad provider comprises storing the data in a registry or hard drive on the computing device.

12. The web browser add-on in claim 7 wherein performing the method of selecting the ad provider, further comprises modifying a document on the computing device based on the data.

13. The web browser add-on in claim 7 where the web browser add-on comprises at least one selected from the list of: add-in, extension, plug-in, and helper object.

14. A computer-readable medium having computer-executable instructions for performing a method of selecting an ad provider for a computing device, the computing device having a display and the ad provider involved in a process of providing ads for display on the display, the method comprising:
providing a user interface on the display, the user interface configured to allow selection of an ad provider;
receiving an indication of a first ad provider; and
storing data corresponding to the first ad provider in a memory associated with the computing device.
